(19) United States
(12) Patent Application Publication
(10) Pub. No.: US 2011/0099760 A1
(43) Pub. Date: May 5, 2011

(54) ROTARY SHAFT STRUCTURE

(76) Inventors: Ming-Syong WUN, Taoyuan County (TW); Chun-Chang CHAN, Taoyuan County (TW)

(21) Appl. No.: 12/613,022

(22) Filed: Nov. 5, 2009

(51) Int. Cl. E05D 11/08

(52) U.S. Cl. 16/337

(57) ABSTRACT

A rotary shaft structure includes a case, a first shaft fitted in the case with an end of the first shaft outward extended from an end of the case; a second shaft fitted in the case with an end of the second shaft outward extended from an opposing end of the case opposite to the first shaft; and a push unit arranged in the case to locate between the first and the second shaft. The rotary shaft structure is simplified and can be coupled to and between a main body and a display of a notebook computer, enabling easy open of the display without causing a rearward tilted main body and slow close of the display without impacting against the main body.

### FIELD OF THE INVENTION

The present invention relates to an improved rotary shaft structure, and more particularly to a simplified rotary shaft structure for coupling to and between two members to enable easy open of one member relative to the other member and slow close of one member without impacting against the other member.

### BACKGROUND OF THE INVENTION

A conventional rotary shaft structure for a notebook computer includes a first fixing plate and a second fixing plate respectively connected to a main body and a display of the notebook computer. A shaft is extended from one side of the first fixing plate, and a washer is riveted to an end of the shaft. A plurality of washers is provided on the shaft at two sides of the second fixing plate, so that the washers are in frictional contact with the second fixing plate to thereby provide an appropriate torsion, allowing the first and the second fixing plate to rotate properly.

In the above-described conventional rotary shaft structure, the needed torsion is obtained by clamping the washers and the second fixing plate together. The large number of washers brings complexity in the structural design of the rotary shaft structure and inconvenience in installing the rotary shaft. Further, in consideration of the exterior design of the notebook computer, in most cases, the relatively heavy battery for the computer is arranged in the main body near a rear half thereof close to the rotary shaft structure. With this arrangement, the main body of the notebook computer usually has a very heavy rear half. When lifting the display open, since the torsion needed to open the second fixing plate from the first fixing plate is relatively high and the main body has a heavier rear half, the main body of the notebook computer tends to tilt rearward along with the lifting display. When the display has been lifted to a predetermined open angle, the torsion becomes reduced. At this point, due to the weight thereof, the main body would suddenly drop from the tilted position to undesirably impact on the desktop. To prevent the main body of the notebook from tilting along with the turning open display, a user has to hold the main body down with one hand while opening the display. This is of course very inconvenient for the user to do so.

It is therefore desirable and tried by the inventor to develop an improved and simplified rotary shaft structure for the main body and the display of a notebook computer, for example, so that the display can be easily opened without tilting the main body at the same time and, on the other hand, be slowly closed without impacting on the main body.

### SUMMARY OF THE INVENTION

A primary object of the present invention is to provide a simplified but improved rotary shaft structure for coupling to and between two members, such as a display and a main body of a notebook computer, so that the display can be easily opened relative to the main body without bringing a rearward tilted main body and be slowly closed without impacting against the main body.

To achieve the above and other objects, the rotary shaft structure according to a preferred embodiment of the present invention includes a case, a first shaft fitted in the case with an end of the first shaft outward extended from an end of the case; a second shaft fitted in the case with an end of the second shaft outward extended from an opposing end of the case opposite to the first shaft; and a push unit arranged in the case to locate between the first and the second shaft.

The first shaft can be coupled with a main body of a notebook computer, and the second shaft can be coupled with a display of the notebook computer. Through cooperative movements among the case, the first and second shafts, and the push unit, the display can be easily opened without bringing the main body to tilt rearward and be slowly closed without impacting against the main body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a rotary shaft structure according to a first embodiment of the present invention;

FIG. 2 is a longitudinal sectional view of the rotary shaft structure of FIG. 1;

FIG. 3 shows the rotary shaft structure according to the first embodiment of the present invention in use;

FIG. 4 is a perspective view showing a rotary shaft structure according to a second embodiment of the present invention;

FIG. 5 is a longitudinal sectional view of the rotary shaft structure of FIG. 4; and

FIG. 6 shows the rotary shaft structure according to the second embodiment of the present invention in use.

### DETAILED DESCRIPTION OF THE PREFERRED EMBODIMENTS

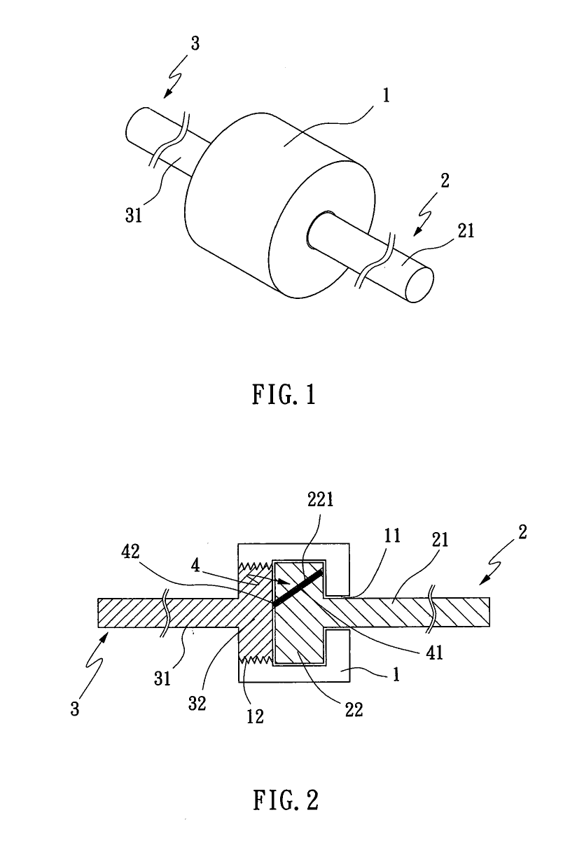

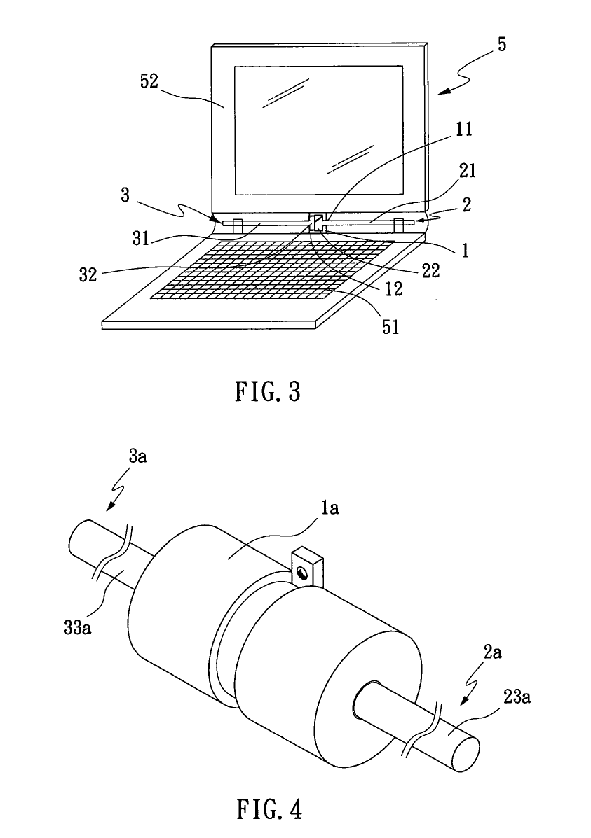

Please refer to FIGS. 1 and 2 that are perspective and longitudinal sectional views, respectively, showing a rotary shaft structure according to a first embodiment of the present invention, and to FIG. 3 that shows the rotary shaft structure of the first embodiment in use. As shown, the rotary shaft structure in the first embodiment of the present invention includes a case 1, a first shaft 2, a second shaft 3, and a push unit 4.

The case 1 is provided at a first end with a through hole 11 and at an opposing second end with an internally threaded opening 12.

The first shaft 2 includes a shaft portion 21 that is outward extended through the through hole 11, and a shaft base 22 that is movably fitted in the case 1 behind the through hole 11 and is provided at a predetermined position with an obliquely extended receiving space 221.

The second shaft 3 includes a shaft portion 31 that is outward projected from the internally threaded opening 12, and a connecting base 32 engaged with the internally threaded opening 12.

The push unit 4 includes an elastic element 41 arranged in the receiving space 221, and an interfering element 42 located at an end of the elastic element 41 to press against an end face of the connecting base 32 facing toward the shaft base 22.

To use the rotary shaft structure according to the first embodiment of the present invention, the shaft portion 21 of the first shaft 2 is coupled with a main body 51 of a notebook computer 5, and the shaft portion 31 of the second shaft 3 is coupled with a display 52 of the notebook computer 5. To open the display 52 of the notebook computer 5, the display 52 is lifted in a direction away from the main body 51. At this point, the second shaft 3 is brought to rotate along with the case 1 and causes the interfering element 42 of the push unit 4 to compress the elastic element 41. As a result, the interfering element 42 retracts into the receiving space 221 to allow easy open of the display 52 without tilting the main body 51 of the notebook computer 5 due to an exceeded torsional force.

And, to close the display 52 of the notebook computer 5, the display 52 is turned toward the main body 51 to cover onto the main body 51. When the display 52 is turned, the second shaft 3 is brought to rotate along with the case 1, and the first shaft 2 is also brought to rotate. At this point, the elastic element 41 of the push unit 4 is elastically released to push the interfering element 42 outward in the receiving space 221, bringing the interfering element 42 to press against the end face of the connecting base 32 again. Since the interfering element 42 is now in frictional contact with the end face of the connecting base 32, a user has to apply a relatively large force to close the display 52. That is, the display 52 is covered onto the main body 51 slowly without the risk of impacting against the main body 51 due to an excessively applied force to the display 52 by the user.

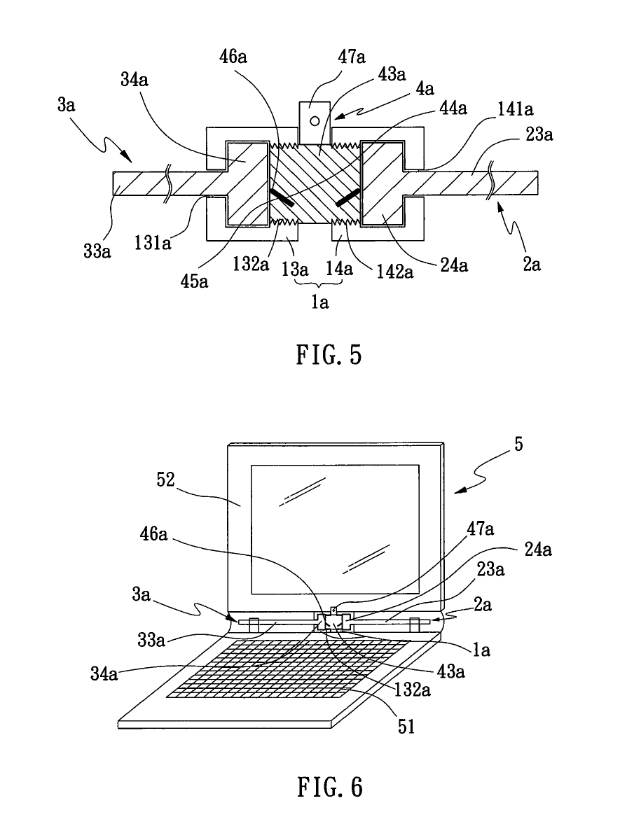

FIGS. 4 and 5 are perspective and longitudinal sectional views, respectively, showing a rotary shaft structure according to a second embodiment of the present invention, and to FIG. 6 that shows the rotary shaft structure of the second embodiment in use. As shown, the rotary shaft structure in the second embodiment of the present invention includes a case 1a, a first shaft 2a, a second shaft 3a, and a push unit 4a. The rotary shaft structure in the second embodiment is generally structurally similar to the first embodiment, except that the case 1a includes two case portions 13a, 14a arranged end to end. The case portions 13a, 14a are respectively provided on a first end with a through hole 131a, 141a, and on an opposing second with an internally threaded opening 132a, 142a. The first shaft 2a includes a shaft portion 23a that is outward extended through the through hole 141a, and a shaft base 24a that is movably fitted in the case portion 14a behind the through hole 141a. Similarly, the second shaft 3a includes a shaft portion 33a that is outward extended through the through hole 131a, and a shaft base 34a that is movably fitted in the case portion 13a behind the through hole 131a. The push unit 4a includes a holding base 43a engaged at two opposite ends with the internally threaded openings 132a, 142a of the case portions 13a, 14a, respectively; two receiving spaces 44a obliquely located at two opposing ends of the holding base 43a; two elastic elements 45a separately arranged in the two receiving spaces 44a; an interfering element 46a located at an end of each of the elastic elements 45a to press against an end face of each of the shaft bases 24a, 34a; and a fastening plate 47a provided on one side of the holding base 43a.

To use the rotary shaft structure according to the second embodiment of the present invention, the shaft portions 23a, 33a of the first shaft 2a and the second shaft 3a are coupled with a main body 51 of a notebook computer 5, and the holding base 43a of the push unit 4a is coupled with a display 52 of the notebook computer 5 via the fastening plate 47a. To open the display 52 of the notebook computer 5, the display 52 is lifted in a direction away from the main body 51. At this point, the case 1a and the holding base 43a of the push unit 4a are brought to rotate at the same time. Meanwhile, since the interfering elements 42 are not in frictional contact with the first and the second shaft 2a, 3a, allowing the display 52 to be easily opened without tilting the main body 51 of the notebook computer 5 due to an exceeded torsional force.

And, to close the display 52 of the notebook computer 5, the display 52 is turned toward the main body 51 to cover onto the main body 51. When the display 52 is turned, the case 1a and the holding base 43a of the push unit 4a are brought to rotate at the same time. Meanwhile, the elastic elements 45a of the push unit 4a are caused to push the interfering elements 46a outward in the receiving spaces 44a, bringing the interfering elements 46a to press against and in frictional contact with the end faces of the shaft bases 24a, 34a of the first and second shafts 2a, 3a, respectively. Since the interfering elements 46a are now in frictional contact with the end faces of the shaft bases 24a. 34a, a user has to apply a relatively large force to close the display 52. That is, the display 52 is covered onto the main body 51 slowly without the risk of impacting against the main body 51 due to an excessively applied force to the display 52 by the user.

The present invention provides a novel, simplified and improved rotary shaft structure that includes a case, a first and a second shaft, and a push unit, and can be coupled to and between a main body and a display of a notebook computer to allow easy open and slow close of the display relative to the main body. With these advantages, the rotary shaft structure of the present invention is industrial useful and any products derived therefrom would no doubt satisfy the market demands.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A rotary shaft structure, comprising:
a case;
a first shaft being fitted in the case with an end of the first shaft outward extended from an end of the case;
a second shaft being fitted in the case with an end of the second shaft outward extended from an opposing end of the case opposite to the first shaft; and
a push unit being arranged in the case to locate between the first and the second shaft.

2. The rotary shaft structure as claimed in claim 1, wherein the case is provided at the two opposing ends with a through hole and an internally threaded opening; the end of the first shaft that is outward extended from the case being a shaft portion that extends through the through hole on one end of the case, and an opposing end of the first shaft being a shaft base movably fitted in the case behind the through hole and being provided at a predetermined position with an obliquely extended receiving space; the end of the second shaft that is outward extended from the case being a shaft portion that projects from the internally threaded opening on the opposing end of the case, and an opposing end of the second shaft being a connecting base engaged with the internally threaded opening; and the push unit including an elastic element arranged in the receiving space in the shaft base of the first shaft, and an interfering element located at an end of the elastic element to press against an end face of the connecting base facing toward the shaft base.

3. The rotary shaft structure as claimed in claim 1, wherein the case includes two case portions arranged end to end; each of the two case portions being provided at two opposing ends with a through hole and an internally threaded opening; the ends of the first and second shafts that are outward extended from the case being two shaft portions that separately extend through the through holes on the two case portions, and opposing ends of the first and second shafts being two shaft bases separately movably fitted in the two case portions behind the through holes; and the push unit including a holding base engaged at two opposite ends with the internally threaded openings of the two case portions, two receiving spaces separately obliquely provided at the two opposite ends of the holding base, two elastic elements separately arranged in the two receiving spaces, two interfering elements separately located at an end of the two elastic elements to press against end faces of the shaft bases of the first and second shaft facing toward the holding base; and a fastening plate provided on one side of the holding base.
